(19) United States
(12) Patent Application Publication
(10) Pub. No.: US 2007/0234133 A1
(43) Pub. Date: Oct. 4, 2007

(54) Device and method for testing memory access time using PLL

(75) Inventors: Yong-Jae Choo, Seoul (KR); Sang-min Bae, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/706,996

(22) Filed: Feb. 16, 2007

(30) Foreign Application Priority Data
Feb. 28, 2006 (KR) 10-2006-0019495

(51) Int. Cl. G11B 20/20; G06K 5/04; G11B 5/00

(52) U.S. Cl. 714/700

(57) ABSTRACT

A device and method for testing memory access times of a memory using a phase-locked loop (PLL) are described. The device for testing the memory access time of a memory may include a PLL and a test unit, and may also include a memory controller. The PLL may generate a test signal having a variable period. The test unit may compare the test signal with a memory output and may output the result of the comparison as a test result for the memory access time. The test unit may include a delay portion and a test portion. The delay portion may delay the test signal to generate first to n-th (n may be a natural number) sub-test signals. The test portion may compare the first to n-th sub-test signals with the memory output.

### PRIORITY STATEMENT

This application claims the benefit of Korean Patent Application No. 10-2006-0019495, filed on Feb. 28, 2006, in the Korean Intellectual Property Office, the entire contents of which are incorporated herein by reference.

### BACKGROUND

1. Field

Example embodiments are directed to a device and method for testing the memory access time of a memory using a phase-locked loop (PLL).

2. Description of the Related Art

FIG. 1 is a schematic block diagram of a conventional test device 10 having an access-time measurement block (AMB).

Referring to FIG. 1, the conventional test device 10 may include the AMB for testing a memory access time of a memory 12. The AMB may include delay chains 14 for testing the memory access time of the memory 12. The delay chains 14 may generate a plurality of input clock signals CLK which may have different periods from each other.

The plurality of clock signals CLK having different periods from each other may be transmitted to a comparison logic unit 16 of the AMB. The comparison logic unit 16 may compare the plurality of clock signals CLK to an output of the memory 12. The memory access time of the memory 12 may be determined by finding the clock signal with the same period as the output of the memory 12 among the plurality of clock signals CLK.

However, the conventional test device may include delay chains corresponding to various periods in order to generate clock signals with different periods, and thus area usage efficiency may be reduced and resources limited. In addition, there may be many variables associated with silicon characteristics when testing the memory access time using the delay chains. Moreover, testable memory access times may be limited by previously-set resources, for example, the delay chains.

### SUMMARY

Example embodiments are directed to a test device and method for testing the memory access time of a memory.

A device for testing the memory access time of a memory may include a PLL (phase-locked loop) for generating a test signal having a variable period and a test unit for comparing the test signal with a memory output and outputting the result of the comparison as a test result for the memory access time. The device may also include a memory controller for transmitting a memory control signal having a longer period than the test signal to the memory; the test unit may be activated in response to the memory control signal.

The test unit may include a delay portion for delaying the test signal in order to generate first to n-th (n may be a natural number) sub-test signals, and a test portion for comparing the memory output with the corresponding first to n-th sub-test signals. The k-th sub-test signal (1≦k≦n, k may be a natural number) may be obtained by delaying the test signal by (k−1) times the period of the test signal.

The delay portion may include first to n-th delay flip-flops, and the test portion may include first to n-th test flip-flops.

The first to n-th delay flip-flops may respectively output the corresponding first to n-th sub-test signals in response to a test enable signal. The test enable signal may be synchronized with a memory clock signal, which may be an operating clock signal of the memory activated in response to the memory control signal. The test enable signal may be the inverted memory control signal. The device may further include a test enable signal generator for generating the test enable signal.

The first to n-th test flip-flops may respectively compare the corresponding first to n-th sub-test signals with the memory output and may output the results of the comparison. When the corresponding sub-test signal is coincident with the memory output, the test flip-flop may output a logic-high signal.

The memory access time may be between a lower bound and an upper bound. The lower bound may be the time determined by adding a propagation delay time of the sub-test signal having the longest delay time, among delay times of the sub-test signals input to the flip-flops which output a logic-low L, to the period of the test signal. The upper bound may be the time determined by adding a propagation delay time of the sub-test signal having the shortest delay time, among delay times of the sub-test signals input to the flip-flops which output a logic-high signal, to the period of the test signal.

The device may further include a slow signal generator for generating a slow signal by dividing the test signal by 2^{m} (m may be a natural number). The slow signal generator may include m divider flip-flops. The memory controller may invert the slow signal in response to the enable signal in order to produce the memory control signal.

The memory may be RAM (random-access memory). The device may be included in a BIST (built-in self-test) circuit.

A method of testing the memory access time of a memory may include generating a test signal having a variable period using a PLL, generating a memory control signal having a longer period than the test signal, transmitting the memory control signal to the memory, comparing the test signal with a memory output activated in response to the memory control signal, and determining the memory access time.

Testing the memory access time may include generating first to n-th (n may be a natural number) sub-test signals using the test signal, and comparing the corresponding first to n-th sub-test signals with the memory output.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a schematic block diagram of a conventional test device having an access-time measurement block (AMB).

FIG. 2 is a block diagram of an example test device for testing the memory access time of a memory using a phase-locked loop (PLL) according to example embodiments.

FIG. 3 is a circuit diagram of the example test device of FIG. 2.

FIG. 4 is a block diagram of an example test device for testing the memory access time of a memory according to example embodiments.

FIG. 5 is a schematic block diagram of an example semiconductor device having a built-in self-test (BIST) circuit, and including the example test device of FIG. 2 or the example test device of FIG. 4.

FIG. 6 is a flowchart of a method of testing the memory access time of a memory using a PLL according example embodiments.

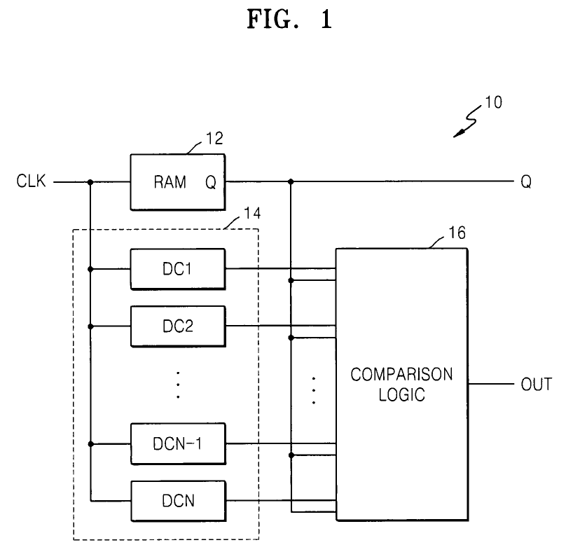

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

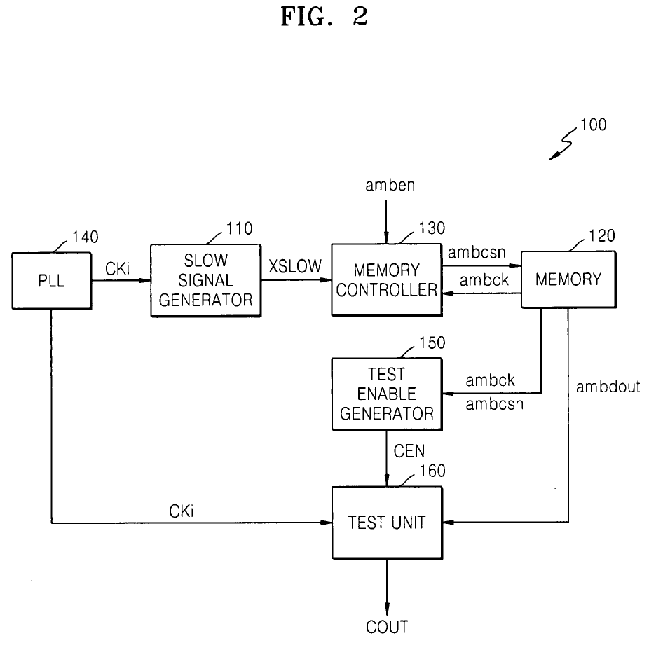

FIG. 2 is a block diagram illustrating an example test device 100 for testing memory access times of a memory unit 120 using a phase-locked loop (PLL) 140 according to example embodiments.

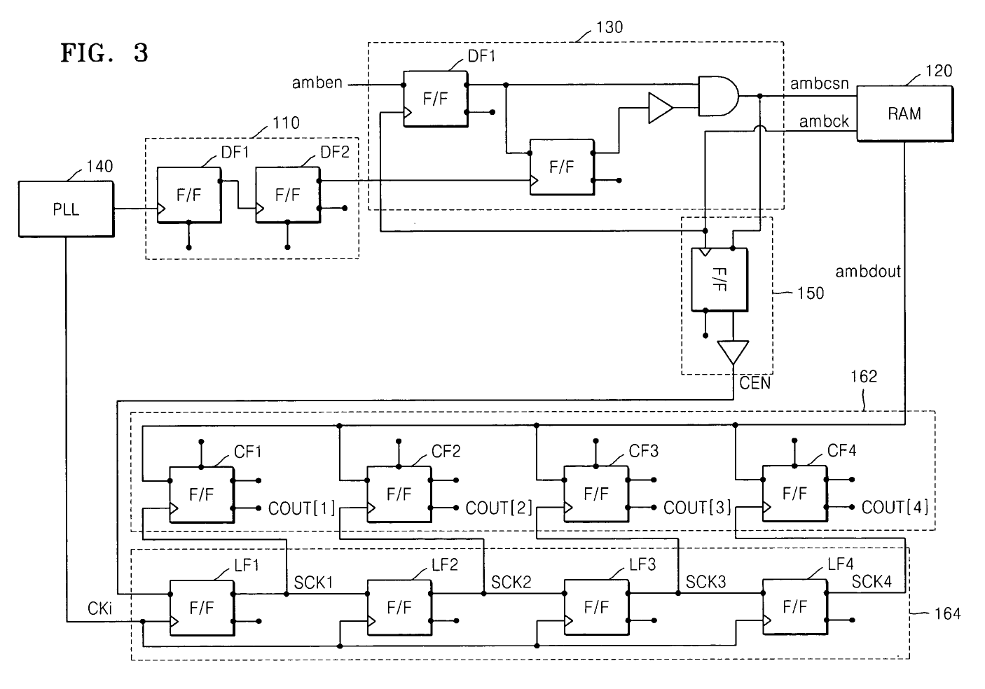

FIG. 3 is a circuit diagram illustrating the example test device 100.

Referring to FIGS. 2 and 3, the test device 100 may include the PLL 140, a memory controller 130 and a test unit 160.

The PLL 140 may generate a test signal CKi having a variable period, which may be set by the user. The period of the test signal CKi may be set to a memory access time according to the specification of the memory unit 120 to be tested. For example, when the memory access time according to the specification of the memory unit 120 is about 5 ns, the test signal CKi may be generated with a clock having a period of about 5 ns.

The memory controller 130 may generate a memory control signal ambcsn. The memory control signal ambcsn may be related to the activation of the memory unit 120, which may be random-access memory (RAM).

The period of the memory control signal ambcsn may be longer than the period of the test signal CKi. This may be because the memory unit 120 may require a more stable data output than the high-speed operation that may be required for the test signal CKi may provide.

The memory control signal ambcsn may be obtained by inverting a slow signal XSLOW. The slow signal XSLOW may be obtained by dividing the test signal CKi by 2^{m} (m may be a natural number). FIG. 3 illustrates example embodiments in which the slow signal XSLOW may be obtained by dividing the test signal CKi, for example, by 4 by using two divider flip-flops DF1 and DF2.

The memory controller 130 may invert the slow signal XSLOW to generate the memory control signal ambcsn in response to an enable signal amben. The memory controller 130 may include an AND gate configured to receive as inputs the enable signal amben and the slow signal XSLOW, and configured to output the memory control signal ambcsn. The memory unit 120 may output data ambdout in response to the memory control signal ambcsn.

When the enable signal amben is activated, a test enable signal CEN may be activated in synchronization with a memory clock signal ambck. The memory clock signal ambck may be an operation clock signal of the memory unit 120, and may be activated in response to the memory control signal ambcsn. The test enable signal CEN may activate delay flip-flops LF1 to LF4 of the test unit 160.

Referring to FIGS. 2 and 3, the test unit 160 may compare the test signal CKi with a memory output ambdout, which may be activated by the memory control signal ambcsn, and may output a test result COUT relating to the memory access time.

As illustrated in FIG. 3, the test unit 160 may include a delay portion 164 and a test portion 162. The delay portion 164 may delay the test signal CKi, the delayed signals corresponding to sub-test signals SCK1 to SCK4, by using delay flip-flops LF1 to LF4. It should be noted, however, that example embodiments are not limited thereto. The delay portion 164 may, for example, be expanded to include components for any number of delayed test signals CKi, including the appropriate number of corresponding sub-test signals and delay flip-flops.

The test device 100 may further include a test enable signal generator 150 for generating the test enable signal CEN. The test enable signal CEN may be synchronized with the memory clock signal ambck, and may be obtained by inverting the memory control signal ambcsn. The test enable signal generator 150 may include a flip-flop clocked by the memory control signal ambcsn, and an inverter for inverting an output of the flip-flop.

The delay flip-flops LF1 to LF4 may output the sub-test signals SCK1 to SCK4, respectively. For example, the first delay flip-flop LF1 may output the first sub-test signal SCK1, the second delay flip-flop LF2 may output the second sub-test signal SCK2, etc. . . .

The test signals SCK1 to SCK4 may be obtained by delaying the test signal CKi. For example, the k-th sub-test signal (where k may be a natural number and 1≦k≦n) may be obtained by delaying the test signal CKi by (k−1) times the period of the test signal CKi.

For example, if the test signal CKi has a period of about 5 ns, the first sub-test signal SCK1 may be obtained by delaying the test signal CKi by about 0 ns (1−1=0), so that the first sub-test signal SCK1 may be coincident with the test signal CKi. In the same manner, the second sub-test signal SCK2 may be obtained by delaying the test signal CKi by one period of the test signal CKi. Therefore, the second sub-test signal SCK2 may have a propagation delay time of about 5 ns. The third and fourth sub-test signals SCK3 and SCK4 may be obtained in a similar manner, etc. . . .

Referring to FIGS. 2 and 3, the test portion 162 may compare the test signals SCK1 to SCK4 with the memory output ambdout. The test portion 162 may include test flip-flops CF1 to CF4. For example, the first test flip-flop CF1 may compare the first sub-test signal SCK1 with the memory output ambdout, the second test flip-flop CF2 may compare the second sub-test signal SCK2 with the memory output ambdout, etc. . . . According to example embodiments, and as illustrated in FIG. 3, the test portion 162 may include test flip-flops CF1 to CF4 for comparing the sub-test signals SCK1 to SCK4 with the memory output ambdout. It should be noted, however, that example embodiments are not limited thereto. The test portion 162 may, for example, be expanded to include additional test flip-flops testing additional sub-test signals with the memory output ambdout.

According to example embodiments, in order to test the memory access time, the memory output ambdout may be set to 1 and the outputs of the test flip-flops CF1 to CF4 may be set to 0. The test flip-flop may output a logic-high signal when the corresponding sub-test signal is coincident with the memory output ambdout.

The memory access time may be between a lower and upper boundary. The memory access time lower boundary may be the time determined by adding the propagation delay of the sub-test signal having the longest delay time, among sub-test signals whose corresponding flip-flop may output a logic-low L, to the period of the test signal. The memory access time upper boundary may be the time determined by adding the propagation delay of the sub-test signal having the shortest delay time, among sub-test signals whose corresponding flip-flop may output a logic-high signal, to the period of the test signal.

For example, the test flip-flops CF1 to CF4 may output 0111 as a test result for the memory access time by comparing the sub-test signals SCK1 to SCK4 with the memory output ambdout. That is, the first test flip-flop CF1 may output COUT[1] as 0, and the rest of the test flop-flops CF2 to CF4 may output COUT[2] to COUT[4] as 1.

Because the memory output ambdout may be not activated in less than, for example, 5 ns, which may be the time obtained by adding the propagation delay time of the first test flip-flop CF1 to the period of the test signal CKi (0 ns+5 ns), the first test flip-flop CF1 may output a logic-low signal. Also, the memory output ambdout may be activated in less than about 10 ns, which may be the time obtained by adding the propagation delay time of the second test flip-flop CF2 to the period of the test signal CKi (5 ns+5 ns), and thus a logic-high signal may be output by the second test flip-flop CF2. The third and fourth test flip-flops CF3 and CF4 may also output logic-high signals since the memory output ambdout may be activated in less than 10 ns.

Thus, when the test result COUT is 0111, the memory access time may be between about 5 ns and about 10 ns. If a user wants to test the memory access time more precisely, the user may generate the test signal CKi with a period shorter than 5 ns by using the PLL 140, and may test the memory access time in the same manner as described above.

In addition, the user may determine whether the test result COUT is a pass or fail according to a predetermined or given standard. For example, when the test result COUT is 0000 or 0011 or higher, the user may determine that the memory unit 120 may not meet a certain requirement according to the memory specification.

The following table shows selected example property comparisons between an example test device according to example embodiments and a conventional test device using delay chains.

TABLE 1

| | Delay chains | PLL |
|---|---|---|
| Silicon Variation | higher | lower |
| area efficiency | lower | higher |
| measurement range | limited | flexible |

The test device 100 according to example embodiments may use the PLL 140 to generate the test signal CKi for testing the memory access time so that it may be possible to test for various memory access times more precisely. As a result, it may be possible to produce more competitive and reliable memories. Furthermore, the test device 100 according example embodiments may be less influenced by silicon variations than conventional test devices having delay chains. Also, the test device 100 according to example embodiments may have higher area usage efficiency than conventional test devices, and thus may have lower associated costs.

The test device 100 according example embodiments may generate sub-test signals having various propagation delay times from a single test signal so that it may be possible to reduce the time and effort required for testing various memory access times precisely.

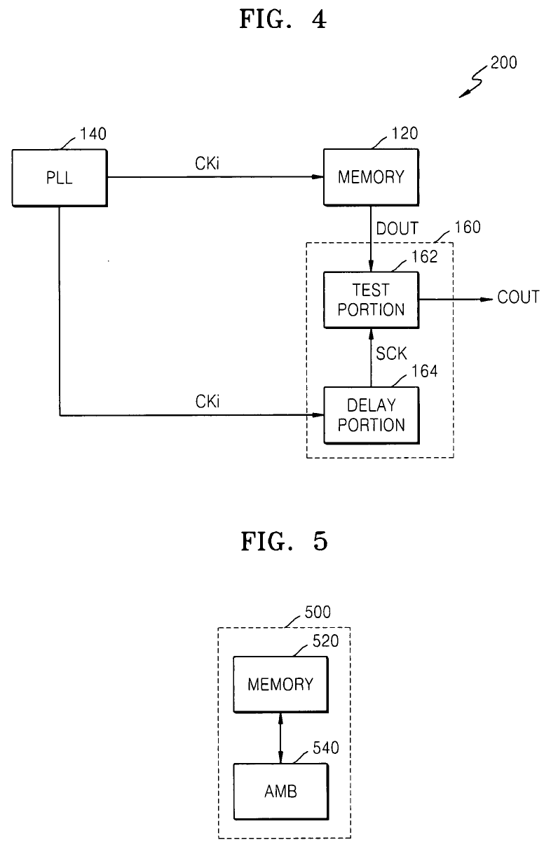

FIG. 4 is a block diagram of an example test device 200 for testing memory access times of a memory unit 120 according to example embodiments.

Referring to FIG. 4, a clock period for operating the memory unit 120 of the test device 200 may be coincident with the period of the test signal CKi produced by the PLL 140. The test unit 160 shown in FIG. 4 may have a similar structure as the test unit 160, including the test portion 162 and the delay portion 164, as shown in FIG. 3.

FIG. 5 is a schematic block diagram of a semiconductor device 500 having a built-in self-test (BIST) circuit that may include the test device of FIG. 2 or the test device of FIG. 4.

Referring to FIG. 5, the semiconductor device 500 may include a test device 540 corresponding to the test device 100 or the test device 200 of FIG. 2 or FIG. 4, respectively, and a memory 520, which may be included in a BIST circuit. The test device 540, as described above, may test for various memory access times in a more precise manner using a PLL.

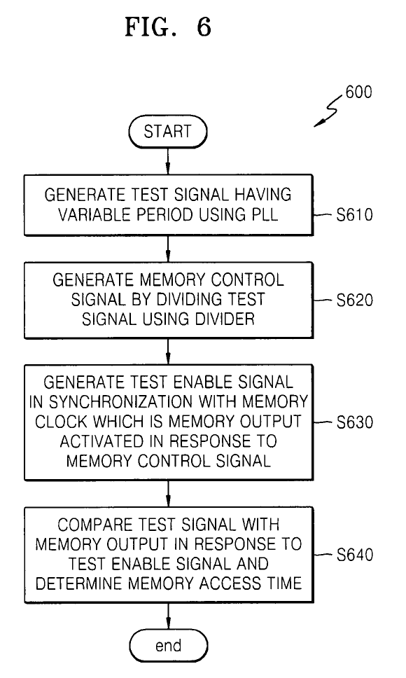

FIG. 6 is a flowchart of a method of testing memory access times of a memory using a PLL according to example embodiments.

Referring to FIG. 6, the method of testing the memory access time of a memory using a test device may include generating a test signal having a variable period using the PLL (operation S610), generating a memory control signal having a period longer than the period of the test signal, transmitting the memory control signal to the memory (operation S620), generating a test enable signal in synchronization with a memory clock which may be a memory output activated in response to the memory control signal (operation S630), and comparing the test signal with the memory output which maybe activated by the memory control signal to determine the memory access time (operation S640).

Because the method of testing memory access times of a memory according to example embodiments may be analogous to the operation of the device for testing memory access times of a memory described above, a detailed description of the method may be omitted. One of ordinary skill in the art will be able to ascertain the relevant details from the discussion above of the device itself.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A device for testing the memory access time of a memory, comprising:
a PLL (phase-locked loop) for generating a test signal having a variable period; and
a test unit for comparing the test signal with a memory output and for outputting the result of the comparison as a test result for the memory access time.

2. The device of claim 1, further comprising:
a memory controller for transmitting a memory control signal having a longer period than the test signal to the memory, wherein the test unit is activated in response to the memory control signal.

3. The device of claim 2, wherein the test unit comprises:
a delay portion for delaying the test signal in order to generate first to n-th (n is a natural number) sub-test signals; and
a test portion for comparing the memory output with the first to n-th sub-test signals.

4. The device of claim 3, wherein the k-th sub-test signal (1≦k≦n, k is a natural number) is obtained by delaying the test signal by (k−1) times the period of the test signal.

5. The device of claim 3, wherein the delay portion includes first to n-th delay flip-flops, and the test portion includes first to n-th test flip-flops.

6. The device of claim 5, wherein the first to n-th delay flip-flops output the corresponding first to n-th sub-test signals in response to a test enable signal.

7. The device of claim 6, wherein the test enable signal is synchronized with a memory clock signal, which is an operating clock signal of the memory activated in response to the memory control signal.

8. The device of claim 7, wherein the test enable signal is the memory control signal inverted.

9. The device of claim 6, further comprising a test enable signal generator for generating the test enable signal.

10. The device of claim 5, wherein the first to n-th test flip-flops compare the corresponding first to n-th sub-test signals with the memory output and output the results of the comparison.

11. The device of claim 10, wherein, when the corresponding sub-test signal is coincident with the memory output, the corresponding test flip-flop outputs a logic-high signal.

12. The device of claim 11, wherein the memory access time is between a lower bound and an upper bound, the lower bound being the time determined by adding the propagation delay time of the sub-test signal having the longest delay time, among delay times of the sub-test signals input to the flip-flops which output a logic-low L, to the period of the test signal, and the upper bound being the time determined by adding the propagation delay time of the sub-test signal having the shortest delay time, among delay times of the sub-test signals input to the flip-flops which output a logic-high signal, to the period of the test signal.

13. The device of claim 2, further comprising a slow signal generator for generating a slow signal by dividing the test signal by 2^{m} (m is a natural number).

14. The device of claim 13, wherein the slow signal generator includes m divider flip-flops.

15. The device of claim 13, wherein the memory controller inverts the slow signal in response to the enable signal in order to produce the memory control signal.

16. The device of claim 1, wherein the memory is RAM (random-access memory).

17. A built-in self-test circuit (BIST) comprising the device of claim 1.

18. The device of claim 1, wherein the test unit comprises:
a delay portion delaying the test signal to generate first to n-th (n is a natural number) sub test signals; and
a test portion comparing the corresponding first to n-th sub test signals with the memory output.

19. The device of claim 18, wherein the k-th sub-test signal (1≦k≦n, k is a natural number) is obtained by delaying the test signal by (k−1) times the period of the test signal.

20. The device of claim 19, wherein the delay portion includes first to n-th delay flip-flops, and the test portion includes first to n-th test flip-flops.

21. The device of claim 20, wherein the first to n-th delay flip-flops respectively output the corresponding first to n-th sub-test signals using the test signal.

22. The device of claim 20, wherein the first to n-th test flip-flops respectively compare the first to n-th sub-test signals with the memory output and output the results of the comparison.

23. The device of claim 22, wherein, when a sub-test signal corresponding to any one of the first to n-th test flip-flops is coincident with the memory output, the corresponding test flip-flop outputs a logic-high signal.

24. The device of claim 18, wherein the memory access time is between a lower bound and an upper bound, the lower bound being the time determined by adding the propagation delay time of the sub-test signal having the longest delay time, among delay times of the sub-test signals input to the flip-flops which output a logic-low L, to the period of the test signal, and the upper bound being the time determined by adding the propagation delay time of the sub-test signal having the shortest delay time, among delay times of the sub-test signals input to the flip-flops which output a logic-high signal, to the period of the test signal.

25. A built-in self-test circuit (BIST) comprising the device of claim 18.

26. A method of testing the memory access time of a memory, comprising:
generating a test signal having a variable period;
generating a memory control signal having a longer period than the test signal and transmitting the memory control signal to the memory; and
comparing the test signal with a memory output activated in response to the memory control signal and determining the memory access time.

27. The method of claim 26, wherein testing the memory access time comprises:
generating first to n-th (n is a natural number) sub-test signals using the test signal; and
comparing the corresponding first to n-th sub-test signals with the memory output.

28. The method of claim 27, wherein the k-th sub-test signal (1≦k≦n, k is a natural number) obtained by delaying the test signal by (k−1) times the period of the test signal.

29. The method of claim 27, wherein generating the first to n-th sub-test signals includes generating the sub-test signals using first to n-th delay flip-flops in response to a test enable signal.

30. The method of claim 29, wherein the test enable signal is synchronized with a memory clock signal, which is an operating clock signal of the memory activated in response to the memory control signal and is the memory control signal inverted.

31. The method of claim 27, wherein comparing the first to n-th sub-test signals with the memory output includes outputting the results of the comparison by the first to n-th test flip-flops.

32. The method of claim 31, wherein, when the sub-test signal corresponding to any one of the first to n-th test flip-flops is coincident with the memory output, the associated test flip-flop outputs a logic-high signal.

33. The method of claim 32, wherein the memory access time is between a lower bound and an upper bound, the lower bound being the time determined by adding the propagation delay time of the sub-test signal having the longest delay time, among delay times of the sub-test signals input to the flip-flops which output a logic-low L, to the period of the test signal, and the upper bound being the time determined by adding the propagation delay time of the sub-test signal having the shortest delay time, among delay times of the sub-test signals input to the flip-flops which output a logic-high signal, to the period of the test signal.
